(19) United States
(12) Patent Application Publication
(10) Pub. No.: US 2012/0271840 A1
(43) Pub. Date: Oct. 25, 2012

(54) SYSTEMS AND METHODS FOR STORING AND PROVIDING SCAN PROTOCOL INFORMATION

(75) Inventors: KENNETH VOSNIAK, WAUKESHA, WI (US); SCOTT DAVID WOLLENWEBER, WAUKESHA, WI (US); ROBERT JOHNSEN, WAUKESHA, WI (US)

(73) Assignee: GENERAL ELECTRIC COMPANY, SCHENECTADY, NY (US)

(21) Appl. No.: 13/093,249

(22) Filed: Apr. 25, 2011

(51) Int. Cl. G06F 17/30

(52) U.S. Cl. 707/758; 707/E17.014

(57) ABSTRACT

A method for displaying a scan protocol for an imaging system is provided. The method includes receiving a current scan protocol for a scan of a patient. The current scan protocol includes scan parameters related to image quality and quantitation. A stored scan protocol is accessed from a memory. The stored scan protocol includes scan parameters related to image quality and quantitation for a previous scan of the patient. The current scan protocol is compared to the stored scan protocol. Any differences are identified based on the comparison of the current scan protocol to the stored scan protocol. The differences of the current scan protocol and the stored scan protocol are indicated on a display.

### BACKGROUND OF THE INVENTION

The subject matter disclosed herein relates generally to imaging systems, and more particularly, to imaging systems using a scan protocol to perform imaging scans.

Imaging systems are generally utilized to generate images of an object, such as an anatomy of interest of a patient. For example, Positron Emission Tomography (PET) systems may be used to generate images of a tumor or lesion in a patient. Often the current image is compared to previous images of the patient's anatomy of interest. The images may be compared to determine differences in the tumor or lesion. In one example, the images are compared to determine an effectiveness of a treatment for the tumor or lesion.

Prior to performing an imaging scan of the anatomy of interest, a current scan protocol is developed. The current scan protocol dictates how the imaging scan will be performed. For example, a speed of the scan and/or an acquisition rate of the image may be dictated by the current scan protocol. The current scan protocol may be based on various parameters, such as a height and weight of the patient, an injection site of a radioactive agent, an uptake time of the radioactive agent, and/or the acquisition and reconstruction techniques such as scan duration, reconstruction iterations, subsets, and filters, which are available when the scan is performed. Generally, the current scan is most conclusive when the current scan protocol is similar to the scan protocol of a previous scan. In particular, differences in scan protocols may result in differences in image quality including quantitation and lesion delineation that make the current scan image less comparable to the previous scan image. Accordingly, because of discrepancies in scan protocol between the current scan and the previous scan, the current scan may be inconclusive or provide inaccurate information, leading to difficulty in determining whether differences are due to the treatment or the manner in which the images were acquired.

The previous scan protocol may be unknown or often not readily available. For example, the previous scan protocol may be determined from the patient's medical record or notes taken by the operator performing the previous scan. However, all of the necessary data for determining the previous scan protocol may be separately recorded in various documents or not entirely recorded. Accordingly, an operator of the imaging system often must sort through a plurality of documents to determine the previous scan protocol. Additionally, the parameters for the current scan protocol may differ from the parameters at the time of the previous scan. As such, the operator must adjust the current scan protocol to compensate for differences in the parameters. Accordingly, the process of determining the optimal scan parameters may be time-consuming and inaccurate. As a result, the current image may not provide the needed clinically relevant information.

### SUMMARY OF THE INVENTION

In one embodiment, a method for displaying a scan protocol for an imaging system is provided. The method includes receiving a current scan protocol for a scan of a patient. The current scan protocol includes scan parameters related to image quality and quantitation. A stored scan protocol is accessed from a memory. The stored scan protocol includes scan parameters related to image quality and quantitation for a previous scan of the patient. The current scan protocol is compared to the stored scan protocol. Any differences are identified based on the comparison of the current scan protocol to the stored scan protocol. The differences of the current scan protocol and the stored scan protocol are indicated on a display.

In another embodiment, a non-transitory computer readable medium is provided. The non-transitory computer readable medium is configured to receive a current scan protocol for a scan of a patient. The current scan protocol includes scan parameters related to image quality and quantitation. A stored scan protocol is accessed from a memory. The stored scan protocol includes parameters related to image quality and quantitation for a previous scan of the patient. The current scan protocol is compared to the stored scan protocol. Any differences are identified based on the comparison of the current scan protocol to the stored scan protocol. The differences of the current scan protocol and the stored scan protocol are indicated on a display.

In another embodiment, a system for displaying a scan protocol is provided. The system includes a memory for storing scan protocols. The stored scan protocols include a plurality of scan parameters related to image quality and quantitation for a previous scan of a patient. A rules engine for accesses a stored scan protocol from the memory. The rules engine compares the stored scan protocol to a current scan protocol to identify differences between the stored scan protocol and the current scan protocol. The current scan protocol includes scan parameters related to image quality and quantitation. A display is provided for displaying the differences between the stored scan protocol and the current scan protocol.

### BRIEF DESCRIPTION OF THE DRAWINGS

The presently disclosed subject matter will be better understood from reading the following description of non-limiting embodiments, with reference to the attached drawings, wherein below:

FIG. 1 is a simplified schematic block diagram of an imaging system formed in accordance with an embodiment.

FIG. 2 is a diagram of the imaging system shown in FIG. 1 coupled to peripheral devices.

FIG. 3 is a flowchart for operating an imaging system in accordance with an embodiment.

FIG. 4 is a block diagram of input to and output from a rules engine formed in accordance with an embodiment.

FIG. 5 is a chart formed in accordance with an embodiment comparing a current scan protocol to a stored scan protocol.

FIG. 6 is a diagram of an exemplary PET imaging system formed in accordance with an embodiment.

### DETAILED DESCRIPTION OF THE INVENTION

The foregoing summary, as well as the following detailed description of certain embodiments, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers, circuits or memories) may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Although the embodiments described herein may be described with respect to a Positron Emission Tomography (PET) system, the embodiments are not limited to such a system. Rather, the embodiments described herein may be utilized with any imaging system, for example, a Single Photon Emission Computed Tomography (SPECT) system, a Magnetic Resonance Imaging (MRI) system, an X-ray system, or the like, as well as, non-medical imaging systems.

Various embodiments provide an imaging system having a memory to store scan protocols from previous imaging scans. The stored scan protocols include a full set of scan parameters used to perform the previous imaging scan. The stored scan protocols may include scan protocols used in a previous scan of a patient. Alternatively, the stored scan protocols may be scan protocols related to a type of scan. The memory allows subsequent or further interaction with the stored scan protocols and scan parameters. For example, the stored scan parameters may be displayed to a user and/or used to populate scan parameters for a current scan. In one embodiment, the stored scan protocol may be compared to a current scan protocol to determine a difference between the stored scan protocol and the current scan protocol. A recommended scan protocol may be generated based on the comparison of the stored scan protocol and the current scan protocol.

The imaging system includes a rules engine that compares at least one stored scan protocol to a current scan protocol to provide notification of differences between the stored scan protocol and the current scan protocol and/or generate a recommended scan protocol. The recommended scan protocol may be a variation of one of the stored scan protocols or the current scan protocol. In one embodiment, the recommended scan protocol may be a combination of at least one of the stored scan protocols and the current scan protocol. The imaging system may utilize the recommended scan protocol or a user selected scan protocol to acquire scan data of an object. An image of the object is generated using the acquired scan data. The imaging system then stores the scan protocols used as a stored scan protocol for subsequent access, such as, for use in future imaging.

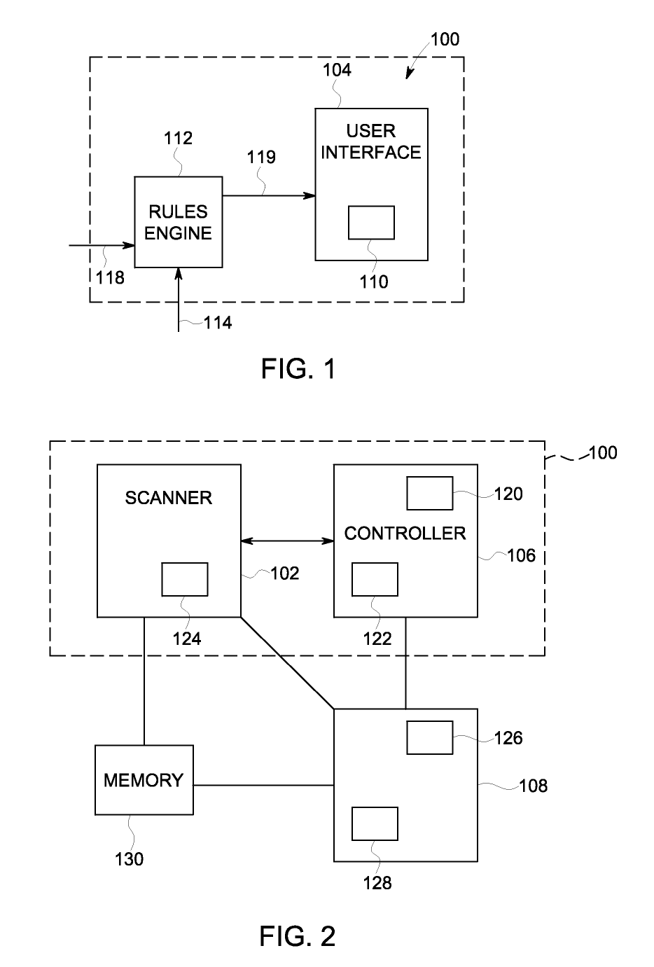

FIG. 1 illustrates an imaging system 100 formed in accordance with an embodiment. The imaging system 100 includes a scanner 102 (shown in FIG. 2) that may be a PET system, a SPECT system, or the like. The scanner 102 performs a scan of an object to acquire scan data of the object. For example, the scanner 102 may perform a scan of an anatomy of interest of a patient using a scan protocol to acquire scan data of the anatomy of interest. The imaging system 100 then may generate an image of the object or anatomy of interest based on the scan data.

The imaging system 100 includes a user interface 104. The user interface 104 may be mechanically coupled to the scanner 102 (e.g. separate workstation) and/or disposed on the scanner 102. Alternatively, the user interface 104 may be part of a controller 106 (shown in FIG. 2) and/or review station 108 (shown in FIG. 2) that is located remotely from the scanner 102. The user interface 104 allows an operator to provide input for performing a scan of the object. For example, the operator may edit and/or change a scan protocol for scanning the object. The operator then utilizes the user interface 104 to initiate the scan. The user interface 104 may include a display 110 to display an image created from the scan data. In some embodiments, the user interface 104 is a virtual or touch sensitive interface presented on the display 110. The operator may manipulate the image at the user interface 104. For example, the operator may rotate the image, enlarge the image, place landmarks on the image, or the like utilizing the user interface 104. The operator may also store the image and/or portions of the image at the user interface 104.

The imaging system 100 includes a rules engine 112. In the illustrated embodiment, the rules engine 112 is disposed within the imaging system 100. The rules engine 112 may be located remotely from and in communication with the imaging system 100 in alternative embodiments. The rules engine 112 receives a current scan protocol 114. In one embodiment, the current scan protocol 114 is received from a remote location 116. Alternatively, the current scan protocol 114 may be input by the operator at the user interface 104. In such an embodiment, the rules engine 112 receives the current scan protocol 114 from the user interface 104. The current scan protocol 114 is defined based on a plurality of parameters for performing the scan of the object. For example, the parameters may include a height and weight of the patient. Alternatively, the parameters may include a dosage of radioactive agent (e.g. radioisotope) received by the patient, an injection site of the radioactive agent, an uptake time of the radioactive agent, and/or the acquisition and reconstruction techniques such as scan duration, reconstruction iterations, subsets, and filters. The parameters may also include various blood levels of the patient, for example, glucose levels of the patient. In one embodiment, the parameters include the type of scan, for example, a scan to determine a change in quantitative tracer uptake and/or tumor/lesion size and delineation after treatment. It should be noted that the parameters listed herein are exemplary only and are not to be considered limiting. The current scan protocol 114 defines how the scan is to be performed based on the parameters. For example, the current scan protocol 114 may define a speed of the scan, a duration of the scan, a resolution of the scan, a reconstruction method, a filter to be used, or the like.

The rules engine 112 may also access a stored scan protocol 118. The stored scan protocol 118 may be stored in the imaging system 100. For example, the stored scan protocol 118 may be stored in the scanner 102 and/or the controller 106. In one embodiment, the stored scan protocol 118 may be stored in the review station 108. In another embodiment, the stored scan protocol 118 may be stored in a remote memory 130 (shown in FIG. 2). In one embodiment, the stored scan protocol 118 may be a previous scan protocol for one of the patient's previous exams and used to populate the protocol parameters for a current scan. Alternatively, the stored scan protocol 118 may be a scan protocol for the type of the scan. For example, a scan protocol may be generated for scans related to identifying a size of a tumor or lesion, for example, detecting a change in quantitative measure of tracer uptake or tumor/lesion size and tumor/lesion delineation. In another example, a scan protocol may be generated for determining the effectiveness of a treatment, such as chemotherapy. The rules engine 112 may access multiple stored scan protocols 118. For example, the rules engine 112 may access the scan protocols from a plurality of previous scans for the patient, as well as, a scan protocol for the type of scan.

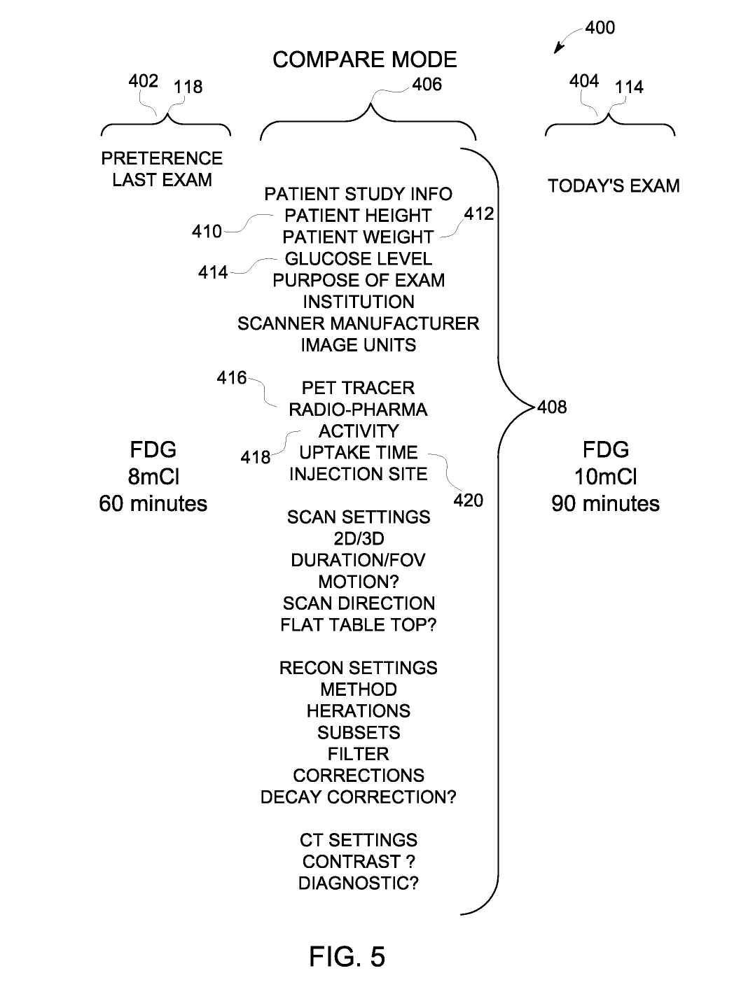

The rules engine 112 allows for the display of the current scan protocol 114 and at least one stored scan protocol 118 on the display 110. The operator can compare the stored scan protocols 118 to the current scan protocol 114 on the display 110. In one embodiment, the rules engine may perform a comparison to identify any differences between the current scan protocol 114 and the stored scan protocol 118. In one embodiment, the differences between the current scan protocol 114 and the stored scan protocol 118 are displayed on the display 110. The differences may be displayed in a chart, such as the chart 400 (shown in FIG. 5). The operator may determine a scan protocol based on the comparison of the stored scan protocol 118 and the current scan protocol 114. In one embodiment, the operator may proceed with the scan using one of the current scan protocol 114 or the stored scan protocol 118. Alternatively, the operator may input a new scan protocol based on the stored scan protocol 118 and the current scan protocol 114. The new scan protocol may include modifications to the stored scan protocol 118 and/or the current scan protocol 114.

In one embodiment, the rules engine 112 may generate a recommended scan protocol 119 for the current scan. The recommend scan protocol 119 may be one of the stored scan protocols 118. Alternatively, the recommended scan protocol 119 may be a modified version of one of the current scan protocol 114 or the stored scan protocol 118. Optionally, the recommended scan protocol 119 may be a combination of or modification of both the current scan protocol 114 and the stored scan protocol 118. The recommended scan protocol 119 is displayed for the operator at the user interface 104. The operator may proceed with the current scan based on the recommended scan protocol 119. Optionally, the operator may proceed based on one of the current scan protocol 114 or the stored scan protocol 118. In one embodiment, the operator may edit the recommended scan protocol 119, the current scan protocol 114, and/or the stored scan protocol 118 at the user interface 104. The recommended scan protocol 119 may include values for one or more of the protocol parameters based on a previous scan or changes in conditions from the previous scan.

In an exemplary embodiment, a scan of the object, for example a patient, is performed using a protocol selected by the user or modified by the user. For example, the scan may be performed based on the current scan protocol 114, the stored scan protocol 118, the recommended scan protocol 119, or a modification of at least one of the current scan protocol 114, the stored scan protocol 118, or the recommended scan protocol 119. During the scan, the rules engine 112 may provide notifications to the operator if the scan varies from the selected scan protocol, for example, the recommended scan protocol 119. The operator may then restart the scan and/or adjust the scan on the fly. After the imaging procedure is completed, the scan protocol used may be stored for future use as a stored scan protocol 118. The scan protocol may be stored as data embedded in the resulting images (in addition to the selected DICOM attributes) and/or may be saved as a separate data set in addition to a protocol selected by the user or modified by the user.

The display of a full set of protocol information/scan parameters from a previous scan, a current scan protocol, or a recommended scan protocol allow a user to interact with the data to facilitate controlling variation in the scanning workflow in a patient's scan. For example, images generated by multiple scans may differ due to differences in the scan protocols utilized for each scan. Often, a follow up scan may be deemed inconclusive or not provide the needed diagnostically relevant information due to these differences. By providing access by, for example, the scanner, to the full set of protocol information/scan parameters from previous scans and for a current scan, the rules engine 112 may increase scanning consistency for images generated by multiple scans. Accordingly, the current scan may be more likely to provide more clinically relevant or conclusive data when compared to previous scans.

FIG. 2 illustrates the imaging system 100 coupled to peripheral devices. The imaging system 100 includes the scanner 102 and the controller 106. The controller 106 generates instructions for controlling the scanner 102. The controller 106 includes a user interface 120. The user interface 120 may be embodied as the user interface 104 described in FIG. 1. The user interface 120 receives inputs for generating and controlling a scan protocol. For example, the current scan protocol 114 (shown in FIG. 1) may be input at the user interface 120. The current scan protocol 114 may include scan parameters related to image quality and quantitation. During an imaging procedure, the operator controls the scanner 102 at the user interface 120. The user interface 120 may display images generated from scan data during and/or after the scan. The operator may view the images at the user interface 120 to determine a quality of the scan data.

In the illustrated embodiment, the controller 106 includes a memory 122. Another memory 124 is provided within the scanner 102. The imaging system 100 may include either memory 122 or 124. Optionally, the imaging system 100 may include both memories 122 and 124. The memories 122 and 124 may store the stored scan protocols 118 (shown in FIG. 1). The stored scan protocols may include scan parameters related to image quality and quantitation. Thus a centralized scheme for storing all information for a specific scan is provided. Accordingly the rules engine 112 (shown in FIG. 1) may access stored scan protocols from at least one of the memories 122 and 124 to display the scan parameters from a previous scan and optionally compare the stored scan protocol to a current scan protocol or generate a recommended scan protocol. The recommended scan protocol may include scan parameters related to image quality and quantitation. A scan protocol is selected by the operator based on at least one of the current scan protocol, the stored scan protocol, or the recommended scan protocol. The scan protocol may then be saved in at least one of the memory 122 or the memory 124. In one embodiment, the rules engine 112 may be provided within the controller 106. Alternatively, the rules engine 112 may be provided within the scanner 102 or may be located remotely from the imaging system 100.

The review station 108 may be located remotely from the imaging system 100. The review station 108 may be positioned in an imaging room with the imaging system 100. Alternatively, the review station 108 may be positioned in a separate room within an imaging center or scan room having the imaging system 100 or positioned at a location remote from the imaging center. In one embodiment, more than one review station 108 may be in communication with the imaging system 100. The review station 108 includes a user interface 126. In one embodiment, the user interface 126 may be embodied as the user interface 104 described in FIG. 1. A memory 128 is provided within the review station 108. The memory 128 may store the scan protocols 118. Accordingly, the rules engine 112, which may be provided at the review station 108 in one embodiment, accesses the stored scan protocols 118 from the memory 128. In one embodiment, the user interface 126 may be utilized to input the current scan protocol 114 so that the current scan protocol 114 is compared to the stored scan protocol 118. The comparison of the current scan protocol 114 to the stored scan protocol 118 may be displayed at the user interface 126. In one embodiment, a recommended scan protocol 119 may be generated based on the comparison of the stored scan protocol 118 to the current scan protocol 114. The recommended scan protocol 119 may be displayed at the user interface 126. The scanner 102 may be controlled at the review station 108 to scan the patient based on at least one of the current scan protocol 114, the stored scan protocol 118, the recommend scan protocol 119 or modifications of at least one of the protocols 114, 118, or 119. Alternatively, a scan protocol is transmitted to the controller 106 so that the controller 106 may be utilized to operate the scanner 102 based on the scan protocol. The review station 108 may store the scan protocol in the memory 128.

In one embodiment, the review station 108 is used to review images generated by the scanner 102. The user interface 126 may display a generated image along with the scan protocol used to generate the image. The user interface 126 may also display the reconstruction methods and parameters used to generate the image. The user interface 126 may also display images from previous scans along with the scan protocols and reconstruction methods used to generate those images. Accordingly, the operator at the review station 108 can assess differences in the images using the scan protocol information, thereby providing improved or more conclusive analysis of the images.

A memory 130 is coupled to the imaging system 100 and the review station 108. The memory 130 may be located in a centralized location. The memory 130 may be provided within an imaging room having the imaging system 100. Alternatively, the memory 130 may be provided within an imaging facility or scan room having the imaging system 100. In yet another embodiment, the memory 130 is provided remotely from the imaging facility, for example, at another imaging facility and/or at a remote imaging/data storage facility. The memory 130 may include stored scan protocols 118 to be retrieved by the rules engine 112. For example, the memory may permanently store a complete set of scan protocol information and scan parameters for previous scans.

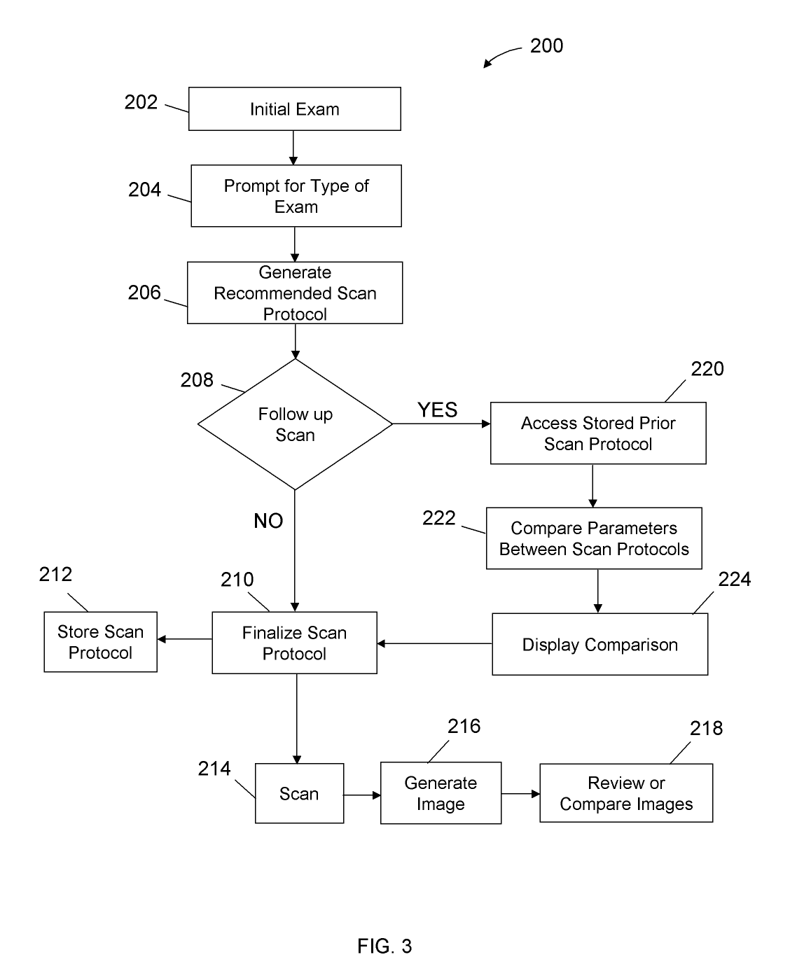

FIG. 3 illustrates a flowchart 200 for operating the imaging system 100. At 202 a patient exam is initiated. During the initiation, various parameters for the current scan protocol 114 may be determined. For example, a technician may enter general information regarding the patient's health. Such information may include the patient's height, weight, and results of current blood work. During the initiation, a purpose for the current scan may be determined to identify the type of scan to perform. In one embodiment, the purpose of the current scan may be to determine an effectiveness of the patient's treatment. As another example, the purpose of the scan may be to detect potential tumors and/or lesions. During the initiation, the patient is prepped for the scan. Such prepping may include injecting the patient with a radioactive agent. The dosage of the radioactive agent, the injection site of the radioactive agent, and an uptake time of the radioactive agent may be used to determine the current scan protocol 114 (shown in FIG. 1).

The initiation of the exam is concluded with prompting the technician for a type of scan to be performed, at 204. The current scan protocol 114 is generated at, 206. The rules engine 112 (shown in FIG. 1) receives the current scan protocol 114. At 208, the rules engine determines whether the scan is a follow up scan and a previous stored scan protocol 118 (shown in FIG. 1) for the patient exists. If the current scan 114 is not a follow up, the scan protocol is finalized as a recommend scan protocol 119, at 210, and stored, at 212, for future reference. The operator may store the scan protocol for the scan in one of the memories 122, 124, 128, and/or 130 to be used in the future as a stored scan protocol 118. At 214, the scan is performed based on the recommended scan protocol, at 214, and an image is generated at 216. At 218, the image may be reviewed.

If the current scan is a follow up scan, the rules engine 112 may retrieve a stored scan protocol 118. The previous stored scan protocol 118 may be stored in one of the memories 122, 124, 128 or 130 (shown in FIG. 2). If previous stored scan protocols 118 exist, the previous stored scan protocols 118 are accessed by the rules engine 112 at 220. At 222, the rules engine 112 compares the current scan protocol 114 to the stored scan protocols 118 to determine if any differences exist between the current scan protocol 114 and the stored scan protocol 118. At 224, a comparison of the current scan protocol 114 and the stored scan protocols 118 may be displayed on the user interface 104 (shown in FIG. 1) including identifications (e.g. highlighting) of any differences. The comparison may be displayed in a chart, for example, the chart 400 shown in FIG. 5.

The scan protocol is finalized as a recommend scan protocol 119, at 210, and stored, at 212, for future reference. The operator may store the scan protocol for the scan in one of the memories 122, 124, 128, and/or 130 to be used in the future as a stored scan protocol 118. At 214, the scan is performed based on the recommended scan protocol 119, at 214, and an image is generated at 216. At 218, the image may be compared to previous images generated for the patient.

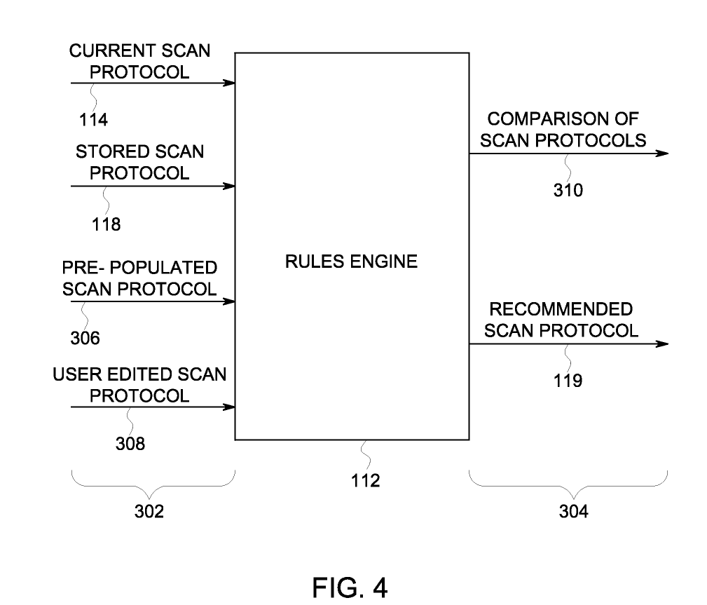

FIG. 4 is a block diagram of one embodiment of input(s) 302 to and output(s) 304 from the rules engine 112. In the illustrated embodiment, the rules engine 112 may receive a plurality of inputs (four types of inputs 302 are shown). The inputs 302 are exemplary only and are not limited to the inputs 302 illustrated in FIG. 4. Additionally, the rules engine 112 may receive any combination of inputs 302. In one embodiment, the input 302 includes a current scan protocol 114 and/or at least one stored scan protocol 118. The input 302 may also include a pre-populated scan protocol 306, such as a recommended scan protocol. The pre-populated scan protocol 306 may include pre-populated scan parameters based on previous scans and/or the type of scan. The input 302 may also include a user edited scan protocol 308. For example, an operator may modify a scan protocol suggested by a doctor, or provided in the patient's medical records. The operator may enter the edited scan protocol 308 at the user interface 104 (shown in FIG. 1).

In the illustrated embodiment, the rules engine 112 produces one or more outputs 304. The outputs 304 are exemplary only and are not limited to the outputs 304 illustrated in FIG. 4. Additionally, the rules engine 112 may produce any combination of outputs 304. In the illustrated embodiment, the outputs 304 include a comparison 310 of the scan protocols input into the rules engine 112. The comparison 310 may be displayed on the user interface, for example, on a chart 400, as illustrated in FIG. 5. The rules engine 112 may also output a recommended scan protocol 119 based on the input 302. The recommended scan protocol 119 may also be displayed on the user interface 104. The operator may review the comparison 310 and the recommended scan protocol 119 to determine an appropriate scan protocol for scanning the patient.

FIG. 5 illustrates a chart 400 generated in accordance with an embodiment and comparing a current scan protocol 114, a recommended scan protocol, or edited scan protocol to a stored scan protocol 118. The chart 400 may be displayed on the user interface 104 (shown in FIG. 1) and/or on any other user interface. A first column 402 displays a previous scan protocol 118, for example, a stored scan protocol 118, and a third column 404 displays the current scan protocol 114. A second column 406 is provided between the first column 402 and the third column 404. The second column 406 identifies the parameters 408 for the current scan protocol 114 and the stored scan protocol 118. The parameters 408 may include a patient height 410, a patient weight 412, a glucose level 414, a radioactive agent 416, a dosage of the radioactive agent 418, and an uptake time of the radioactive agent 420. The parameters 408 shown in the chart 400 are exemplary only and the stored scan protocol 118 and the current scan protocol 114 are not limited to these parameters 408. For example, the parameters may include acquisition and reconstruction techniques such as scan duration, reconstruction iterations, subsets, and filters.

The chart 400 illustrates two parameters 408 that differ between the current scan protocol 114 and the stored scan protocol 118. In the illustrated embodiment, differences exist between the dosage of the radioactive agent 418 and the uptake time of the radioactive agent 420. In particular, the dosage of the radioactive agent 418 for the current scan protocol 114 is ten mCl and the dosage of the radioactive agent 418 for the stored scan protocol 118 is eight mCl. Further, the uptake time 420 for the current scan protocol 114 is ninety minutes and the uptake time 420 for the stored scan protocol 118 is sixty minutes. These differences are displayed on the chart 400 and highlighted, for example using a colored box over the parameters having different values.

The operator may select a scan protocol based on the comparison of the current scan protocol 114 and the stored scan protocol 118 displayed in the chart 400. Optionally, an operator may adjust the current scan protocol 114 based on the comparison. In one embodiment, an operator viewing an image generated with the selected scan protocol may compare the image to a previous image generated by the stored scan protocol 118 using the comparison shown in chart 400.

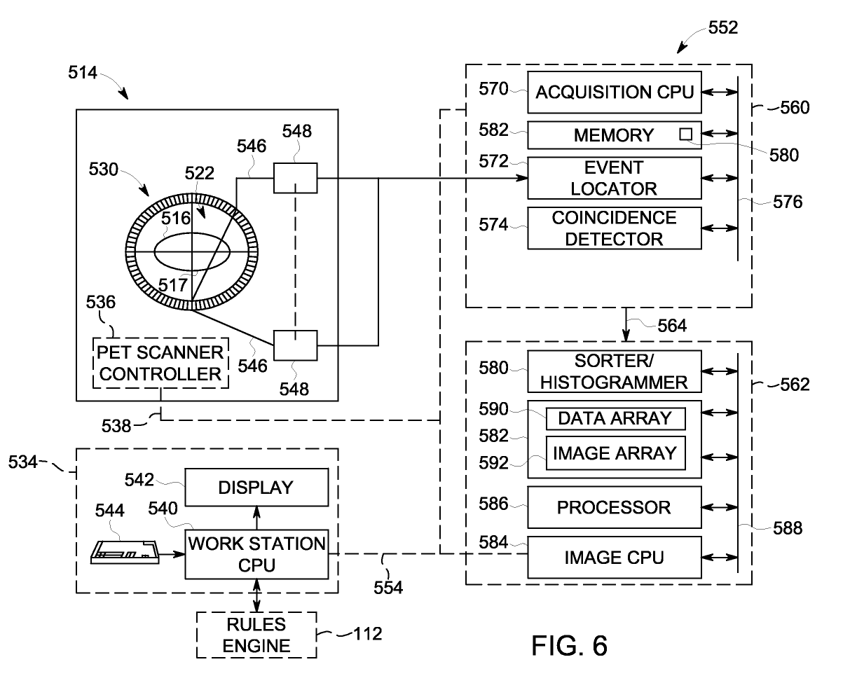

FIG. 6 is a diagram of an exemplary PET imaging system 514 formed in accordance with an embodiment. The PET imaging system 514 may be the imaging system 100 (shown in FIG. 1). The PET imaging system 514 includes a detector ring assembly 530 including a plurality of detector scintillators. The detector ring assembly 530 includes the central opening 522, in which an object or patient, such as object 516 may be positioned, using, for example, a motorized table 524 (not shown in FIG. 6). The scanning operation is controlled from an operator workstation 534 through a PET scanner controller 536. A communication link 538 may be hardwired between the PET scanner controller 536 and the workstation 534. Optionally, the communication link 538 may be a wireless communication link that enables information to be transmitted to or from the workstation to the PET scanner controller 536 wirelessly. In the exemplary embodiment, the workstation 534 controls real-time operation of the PET imaging system 514. The workstation 534 is also programmed to perform medical image diagnostic acquisition and reconstruction processes described herein. The operator workstation 534 includes a central processing unit (CPU) or computer 540, a display 542 and an input device 544. As used herein, the term “computer” may include any processor-based or microprocessor-based system configured to execute the methods described herein.

The methods described herein may be implemented as a set of instructions that include various commands that instruct the computer or processor 540 as a processing machine to perform specific operations such as the methods and processes of the various embodiments described herein. The set of instructions may be in the form of a software program. As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

During operation of the exemplary detector 530, when a photon collides with a scintillator on the detector ring assembly 530, the absorption of the photon within the detector produces scintillation photons within the scintillator. The scintillator produces an analog signal that is transmitted on a communication link 546 when a scintillation event occurs. A set of acquisition circuits 548 is provided to receive these analog signals. The acquisition circuits 548 produce digital signals indicating the 3-dimensional (3D) location and total energy of each event. The acquisition circuits 548 also produce an event detection pulse, which indicates the time or moment the scintillation event occurred.

The digital signals are transmitted through a communication link, for example, a cable, to a data acquisition controller 552 that communicates with the workstation 534 and PET scanner controller 536 via a communication link 554. In one embodiment, the data acquisition controller 552 includes a data acquisition processor 560 and an image reconstruction processor 562 that are interconnected via a communication link 564. During operation, the acquisition circuits 548 transmit the digital signals to the data acquisition processor 560. The data acquisition processor 560 then performs various image enhancing techniques on the digital signals and transmits the enhanced or corrected digital signals to the image reconstruction processor 562 as discussed in more detail below.

In the exemplary embodiment, the data acquisition processor 560 includes at least an acquisition CPU or computer 570. The data acquisition processor 560 also includes an event locator circuit 572 and a coincidence detector 574. The acquisition CPU 570 controls communications on a back-plane bus 576 and on the communication link 564. During operation, the data acquisition processor 560 periodically samples the digital signals produced by the acquisition circuits 548. The digital signals produced by the acquisition circuits 548 are transmitted to the event locator circuit 572. The event locator circuit 572 processes the information to identify each valid event and provide a set of digital numbers or values indicative of the identified event. For example, this information indicates when the event took place and the position of the scintillator that detected the event. The events are also counted to form a record of the single channel events recorded by each detector element. An event data packet is communicated to the coincidence detector 574 through the back-plane bus 576.

The coincidence detector 574 receives the event data packets from the event locator circuit 572 and determines if any two of the detected events are in coincidence. Coincident event pairs are located and recorded as a coincidence data packets by the coincidence detector 574. The output from the coincidence detector 574 is referred to herein as image data. In one embodiment, the image data may be stored in a memory device that is located in the data acquisition processor 560. Optionally, the image data may be stored in the workstation 534.

The image data subset is then transmitted to a sorter/histogrammer 580 to generate a data structure known as a histogram. The image reconstruction processor 562 also includes a memory module 582, an image CPU 584, an array processor 586, and a communication bus 588. During operation, the sorter/histogrammer 580 performs the motion related histogramming described above to generate the events listed in the image data into 3D data. This 3D data, or sinograms, is organized in one exemplary embodiment as a data array 590. The data array 590 is stored in the memory module 582. The communication bus 588 is linked to the communication link 576 through the image CPU 584. The image CPU 584 controls communication through communication bus 588. The array processor 586 is also connected to the communication bus 588. The array processor 586 receives the data array 590 as an input and reconstructs images in the form of image arrays 592. Resulting image arrays 592 are then stored in the memory module 582. The images stored in the image array 592 are communicated by the image CPU 584 to the operator workstation 534.

In the illustrated embodiment, the PET imaging system 514 includes the rules engine 112. The rules engine 112 compares the stored scan protocols 118 (shown in FIG. 1) to the current scan protocol 114 (shown in FIG. 1) to generate the recommended scan protocol 119 (shown in FIG. 1). The computer or processor 540 controls the detector ring assembly 530 of the PET imaging system 514 utilizing at least one of the current scan protocol 114, the stored scan protocol 118, the recommend scan protocol 119, or variations thereof.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claim.

What is claimed is:

1. A method for displaying a scan protocol for an imaging system, the method comprising:
receiving a current scan protocol for a scan of a patient, wherein the current scan protocol includes scan parameters related to image quality and quantitation;
accessing a stored scan protocol from a memory, the stored scan protocol including scan parameters related to image quality and quantitation for a previous scan of the patient;
comparing the current scan protocol to the stored scan protocol;
identifying any differences based on the comparison of the current scan protocol to the stored scan protocol; and
indicating the differences of the current scan protocol and the stored scan protocol on a display.

2. The method of claim 1 further comprising accessing the stored scan protocol from a scanner configured to scan the patient.

3. The method of claim 1 further comprising accessing the stored scan protocol from a memory located in a centralized location.

4. The method of claim 1 further comprising accessing the stored scan protocol from a memory that permanently stores a complete set of scan protocol information and the plurality of scan parameters.

5. The method of claim 1 further comprising pre-populating scan parameters for the current scan protocol.

6. The method of claim 1 further comprising accessing a stored scan protocol that is based on a type of scan.

7. The method of claim 1 further comprising generating a recommended scan protocol based on the comparison of the current scan protocol and the stored scan protocol.

8. The method of claim 1 further comprising performing a scan based on at least one of the current scan protocol, the stored scan protocol, or a recommended scan protocol based on the comparison of the current scan protocol and the stored scan protocol.

9. A non-transitory computer readable medium configured to:
receive a current scan protocol for a scan of a patient, wherein the current scan protocol includes scan parameters related to image quality and quantitation;
access a stored scan protocol from a memory, the stored scan protocol including parameters related to image quality and quantitation for a previous scan of the patient;
compare the current scan protocol to the stored scan protocol;
identify any differences based on the comparison of the current scan protocol to the stored scan protocol; and
indicate the differences of the current scan protocol and the stored scan protocol on a display.

10. The computer readable medium of claim 9 further configured to access the stored scan protocol from a scanner configured to scan the patient.

11. The computer readable medium of claim 9 further configured to access the stored scan protocol from a memory located in a centralized location.

12. The computer readable medium of claim 9 further configured to access the stored scan protocol from a memory that permanently stores a complete set of scan protocol information and the plurality of scan parameters.

13. The computer readable medium of claim 9 further configured to pre-populate scan parameters for the current scan protocol.

14. The computer readable medium of claim 9 further configured to access a stored scan protocol that is based on a type of scan.

15. The computer readable medium of claim 9 further configured to generate a recommended scan protocol based on the comparison of the current scan protocol and the stored scan protocol.

16. The computer readable medium of claim 9 further configured to perform a scan based on at least one of the current scan protocol, the stored scan protocol, or a recommended scan protocol based on the comparison of the current scan protocol and the stored scan protocol.

17. A system for displaying a scan protocol, the system comprising:
a memory for storing scan protocols, the stored scan protocols including a plurality of scan parameters related to image quality and quantitation for a previous scan of a patient;
a rules engine for accessing a stored scan protocol from the memory, the rules engine comparing the stored scan protocol to a current scan protocol to identify differences between the stored scan protocol and the current scan protocol, wherein the current scan protocol includes scan parameters related to image quality and quantitation; and
a display for displaying the differences between the stored scan protocol and the current scan protocol.

18. The system of claim 17, wherein the rules engine generates a recommended scan protocol based on the comparison of the current scan protocol and the stored scan protocol.

19. The system of claim 18 further comprising a scanner to perform a scan of the patient based on at least one of the current scan protocol, the stored scan protocol, or a recommended scan protocol based on the comparison of the current scan protocol and the stored scan protocol.

20. The system of claim 17, wherein the memory permanently stores a complete set of scan protocol information and the plurality of scan parameters.
